(19) United States
(12) Patent Application Publication
(10) Pub. No.: US 2024/0209673 A1
(43) Pub. Date: Jun. 27, 2024

(54) INFORMATION PROCESSING APPARATUS, VEHICLE, AND METHOD

(71) Applicant: TOYOTA JIDOSHA KABUSHIKI KAISHA, Aichi-ken (JP)

(72) Inventor: Takeshi HORI, Shinjyuku-ku (JP)

(21) Appl. No.: 18/536,229

(22) Filed: Dec. 12, 2023

(30) Foreign Application Priority Data
Dec. 22, 2022 (JP) 2022-205420

(51) Int. Cl. E05F 15/70; E05F 15/60

(52) U.S. Cl. CPC E05F 15/70; E05F 15/60; E05Y 2900/55

(57) ABSTRACT

An information processing apparatus receives a first action instructing to start ventilation of an interior space in a vehicle cabin by a user and causes a vehicle to perform a first operation including at least opening a plurality of windows that can be opened and closed and that provided in the vehicle when the first action is received. Further, when a predetermined condition indicating the end of ventilation of the interior space in the vehicle cabin is satisfied, the information processing apparatus causes the vehicle to end the first operation and causes the vehicle to return to the state before performing the first operation.

### CROSS REFERENCE TO RELATED APPLICATION

This application claims the benefit of Japanese Patent Application No. 2022-205420, filed on Dec. 22, 2022, which is hereby incorporated by reference herein in its entirety.

### BACKGROUND

### Technical field

The present disclosure relates to ventilation of an interior space in a vehicle cabin.

### Description of the Related Art

When the compression stop control of the car air conditioner is performed to save power, it is disclosed that the vehicle interior space is ventilated by blowing the outside air into the vehicle interior space with a predetermined air flow amount or more (for example, Patent Document 1).

### CITATION LIST

### Patent Document

[Patent Document 1] Japanese Patent Laid Open No. 2016-147544

One aspect of the disclosure is to provide an information processing method, a vehicle, and a method, capable of reducing the time and effort spent to ventilate an interior space in a vehicle cabin.

### SUMMARY

One aspect of the present disclosure is an information processing apparatus including a controller configured to:
receive a first action instructing to start ventilation of an interior space in a vehicle cabin by a user; and
cause a vehicle to perform a first operation including at least opening a plurality of windows that can be opened and closed and that provided in the vehicle when the first action is received.

Another aspect of the present disclosure is a vehicle including a controller configured to:
receive a first action instructing to start ventilation of an interior space in a vehicle cabin by a user; and
cause a vehicle to perform a first operation including at least opening a plurality of windows that can be opened and closed and that provided in the vehicle when the first action is received.

Another aspect of the present disclosure is a method executed by a computer including:
receiving a first action instructing to start ventilation of an interior space in a vehicle cabin by a user; and
causing a vehicle to perform a first operation including at least opening a plurality of windows that can be opened and closed and that provided in the vehicle when the first action is received.

According to one aspect of the present disclosure, it is possible to reduce the time and effort spent to ventilate the interior space in the vehicle cabin.

### BRIEF DESCRIPTION OF DRAWINGS

FIG. 1 is a diagram illustrating an example of a configuration of a vehicle according to a first embodiment;

FIG. 2 is a diagram illustrating an example of a functional configuration of a control device;

FIG. 3 is an example of a flowchart of a ventilation control process of a vehicle;

FIG. 4 is a diagram illustrating an example of a system configuration of a remote vehicle ventilation control system; and

FIG. 5 is an example of a sequence of ventilation control of a vehicle in a remote vehicle ventilation control system.

### DESCRIPTION OF THE EMBODIMENTS

When ventilating the interior space in the vehicle cabin, it is requested to open a part or all of a plurality of windows that can be opened and closed and that are provided in the vehicle. However, in general, even in a power window, the operation of opening and closing the window needs to be performed individually for each window, and the larger the number of windows that can be opened, the more time and effort it takes. Further, for example, when the driver is riding alone in the vehicle and is driving, it is dangerous to perform an operation of opening a plurality of windows while driving.

In view of the above-described problem, one aspect of the present disclosure makes that a plurality of windows provided in the vehicle are opened by a user performing one action, and ventilation of the interior space in the vehicle cabin is performed. More specifically, one aspect of the present disclosure may be an information processing apparatus including a controller. The information processing apparatus may be, for example, an in-vehicle device, an ECU, an embedded system mounted on a vehicle, a server, or the like. The in-vehicle device may be, for example, a data communication Module (DCM), a car navigation device, a drive recorder, and the like. The controller may be, for example, a processor such as a central processing unit (CPU), a digital signal processor (DSP), or the like.

The controller may receive a first action instructing to start ventilation of the interior space in the vehicle cabin by the user, and may cause a vehicle to perform a first operation including at least opening a plurality of windows that can be opened and closed and that are provided in the vehicle when the first action is received. The first action instructing to start ventilation may include, for example, to press a button instructing to start ventilation, to emit a voice instructing to start ventilation, or to transmit an instruction to start ventilation from a terminal associated with the vehicle. In addition to opening the window, the first operation may include starting an outside air circulation. Further, the window that can be opened in the first operation by the vehicle may be a part or all of the windows that can be opened and closed and that are provided in the vehicle.

In one aspect of the present disclosure, by the user performing the first action, a plurality of windows provided in the vehicle are opened, and the interior space in the vehicle cabin is ventilated. Therefore, according to one aspect of the present disclosure, it is possible to reduce the user's time and effort spent to ventilate the interior space in the vehicle cabin. Further, for example, safe operation can be continued even when the interior space in the vehicle cabin is ventilated while the driver is riding alone and driving.

In one aspect of the present disclosure, when a predetermined condition indicating end of ventilation of the interior space in the vehicle cabin is satisfied, the controller may cause the vehicle to end the first operation and cause the vehicle to return to the state before performing the first operation. The predetermined condition indicating an end of ventilation of the interior space in the vehicle cabin may be, for example, that a second action instructing to end ventilation by a user is received, a predetermined time has elapsed since the start of the first operation, or a predetermined parameter becomes a value indicating the end of ventilation. The second action instructing to end ventilation may be, for example, to press a button instructing to end ventilation, to emit a voice instructing to end ventilation, or to transmit an instruction to end ventilation from a terminal associated with the vehicle.

According to one aspect of the present disclosure, when a predetermined condition indicating the end of ventilation is satisfied, the vehicle automatically returns to the state before the execution of the first operation. For example, when ventilation is completed, the user can close the opened window without doing anything or by performing one action. Therefore, even when ventilation of the interior space in the vehicle cabin is completed, it is possible to reduce the time and effort spent for the user.

In one aspect of the present disclosure, the controller may open a plurality of windows of the vehicle a first amount as a first operation when a button instructing to start ventilation is pressed or when a voice instructing to start ventilation is recognized. Further, when the controller receives an instruction to start ventilation from the terminal, the controller may open a plurality of windows of the vehicle a second amount as a first operation. The second amount is less than the first amount. The case where the button instructing to start ventilation is pressed or the voice instructing to start ventilation is recognized is the case where the user is present in the vehicle cabin. On the other hand, when an instruction to start ventilation is received from the terminal, there is a possibility that the user is away from the vehicle. Therefore, when it is not certain that the user is in the vehicle cabin, the security of the vehicle can be maintained by limiting the amount of opening the window even when receiving an instruction to start ventilation.

In the following, embodiments of the present disclosure will be described with reference to the drawings. The configuration of the embodiments described below are examples, and the present disclosure is not limited to the configuration of the embodiments.

### First Embodiment

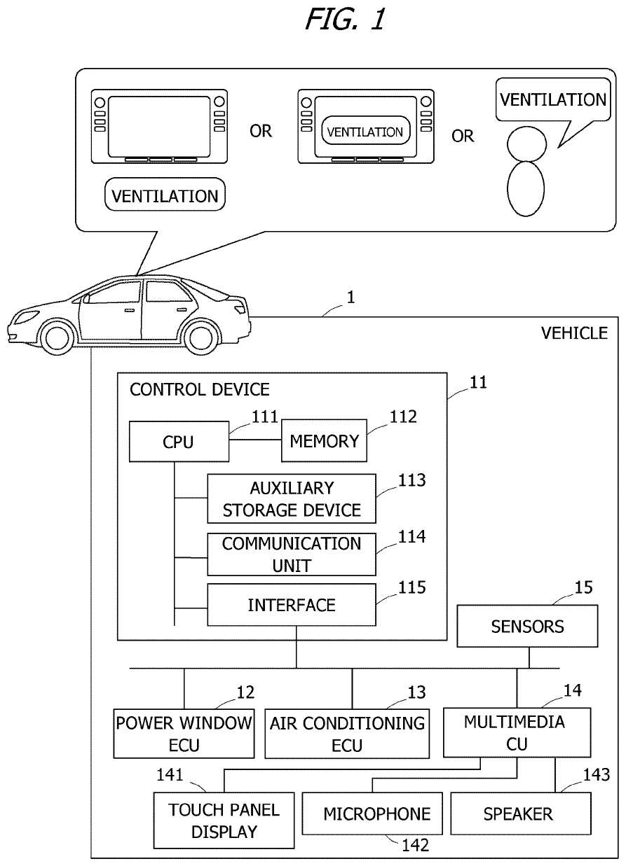

FIG. 1 is a diagram illustrating an example of a configuration of vehicle 1 according to the first embodiment. The vehicle 1 according to the first embodiment opens a plurality of windows that can be opened and closed in order to ventilate the interior space in the vehicle cabin when a first action instructing to start ventilation of the interior space in the vehicle cabin is performed by the occupant. The first action is, for example, to press the “ventilation start” button or to emit a voice instructing to start ventilation. The “ventilation start” button may be a physical button provided inside the vehicle cabin, or may be a button displayed on the touch panel display. As the first action, the vehicle 1 may adopt any one of the above three, or may adopt any two or all of them. Further, in order to ventilate the interior space of the vehicle cabin, the vehicle 1 may further cause the air conditioner to suck in the outside air and to blow the outside air taken in by maximizing the amount of air blown.

In FIG. 1, among the configurations of the vehicle 1, components related to the above functions are extracted and illustrates, and the configuration of the vehicle 1 is not limited to those illustrated in FIG. 1.

The vehicle 1 includes a control device 11, a power window ECU 12, an air conditioning ECU 13, a multimedia ECU 14, and a sensor 15. These components are connected by, for example, a CAN (Controller Area Network) network and an in-vehicle network such as an in-vehicle Ethernet.

The power window ECU 12 is an electronic control unit (ECU) that controls the automatic opening and closing of the window. The power window ECU 12 opens and closes the corresponding window according to the user's operation of the open/close switch of the window installed in the vicinity of the seat, which is installed in each seat. In the driver's seat, there is a switch to open and close for all windows that can be opened and closed. The vehicle 1 illustrated in FIG. 1 is provided with a total of four openable windows on the left and right sides of the front seat and the rear seat. The number and the installation position of windows that can be opened and closed differ depending on the vehicle, and are not limited to the example illustrated in FIG. 1.

The air conditioning ECU 13 is an ECU that controls the air conditioner in the interior space of the vehicle cabin. The multimedia ECU 14 is an ECU that controls a device that inputs or outputs audio and video. The multimedia ECU 14 connects the touch panel display 141, the microphone 142, and the speaker 143. In addition, the vehicle 1 includes a plurality of sensors 15. The sensor 15 includes, for example, an in-vehicle camera, a temperature sensor, a humidity sensor, a carbon dioxide concentration measuring device, and the like.

The control device 11 controls the ventilation of the interior space of the vehicle cabin. The control device 11 may be, for example, a data communication Module (DCM), a car navigation device, a drive recorder, or the like. Alternatively, although illustrated as separate components in FIG. 1, the control device 11 may be a power window ECU 12, an air conditioning ECU 13, or a multimedia ECU 14. The control device 11 is an example of an “information processing apparatus”. In FIG. 1, the control device 11 will be described assuming that it is a data communication device.

The control device 11 includes a CPU 111, a memory 112, an auxiliary storage device 113, a communication unit 114, and an interface 115 as hardware configurations. The auxiliary storage device 113 is, for example, a hard disk drive (HDD), a solid state drive (SSD), and the like. The programs held in the auxiliary storage device 113 include, for example, an OS (Operation System), a plurality of other programs, and the like. The memory 112 includes, for example, a semiconductor memory such as a ROM (Read Only Memory) and a RAM (Random Access Memory). The memory 112 and the auxiliary storage device 113 are examples of computer-readable recording media, respectively.

The CPU 111 executes various processes by loading the OS and various other programs held in the auxiliary storage device 113 into the memory 112 and executing. The CPU 111 is not limited to one, and a plurality of CPUs may be included. The CPU 111 is an example of a “controller”. The communication unit 114 communicates with an external device based on, for example, a mobile communication method such as 5G, 6G, and 4G, Wi-Fi, or a wireless communication method such as Dedicated Short Range Communications (DSRC). The interface 115 is an interface for connecting to an in-vehicle network.

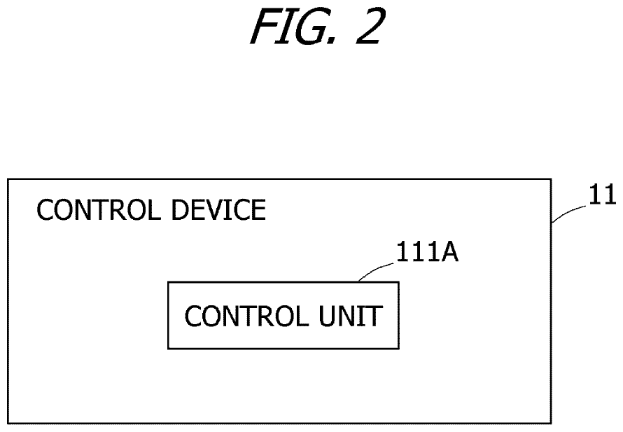

FIG. 2 is a diagram illustrating an example of a functional configuration of the control device 11. The control device 11 includes a control unit 111A as a functional configuration. The control unit 111A is a functional component achieved by the control device 11 executing a predetermined program. The control unit 111A receives the first action by the user in the vehicle cabin. When the first action is to press the “ventilation start” button, for example, the control unit 111A receives a signal input indicating that the “ventilation start” button has been pressed from a signal line (in the case of a physical button) or a touch panel display 141 (in the case of a displayed button). When the first action is to emit a voice instructing to start ventilation, the control unit 111A receives, for example, an input of a sound signal collected from the microphone 142, performs a voice recognition process on the sound signal, and receives the first action when the utterance content acquired as a result of the voice recognition process matches the wording indicating the start of ventilation registered in advance.

When the first action is received, the control unit 111A controls each component so as to cause the vehicle 1 to perform a ventilation operation. In the first embodiment, the ventilation operation includes opening a part or all of a plurality of windows that can be opened and closed and that are provided in vehicle 1 a predetermined amount, and causing the air conditioner to take in outside air and blow the outside air at the maximum air flow amount. Specifically, in the first embodiment, the control unit 111A instructs the power window ECU 12 to open a part or all of the windows that can be opened and closed a predetermined amount, and instructs the air conditioning ECU 13 to take in outside air and blow the outside air taken in at the maximum air flow amount.

In the ventilation operation of the vehicle 1, when opening a part of the windows that can be opened and closed among the plurality of windows provided in the vehicle 1, the right side and the left side of the vehicle 1 may be included in order to improve the passage of air. The amount of opening the window in the ventilation operation may be set by, for example, the ratio of the degree of opening to the time of full opening, or the amount of lowering the window. The amount of lowering the window may be set, for example, in units of a descending length, or by the time or power to move the motor for the lowering. In the first embodiment, the amount of opening the window in the ventilation operation may be fixed, or may be fluctuated according to the outside air temperature, the presence or absence of heating or cooling operation, the season, and the like by the control unit 111A. For example, when the outside air temperature is lower than a predetermined value, when heating is used, or in winter, in order to avoid cold air entering, the control unit 111A may determine the amount of opening the window is about one-third of when fully opened. For example, when the outside air temperature is higher than a predetermined value, or in the case of midsummer, it is pleasant to have a large amount of outside air coming in through the window while the vehicle 1 is traveling. Therefore, the control unit 111A may determine to fully open the window. For example, when cooling is used, in order to keep the cold air in the vehicle cabin as much as possible against the outside air coming in from the window, the control unit 111A may determine the amount of opening the window to about one-third when the window is fully opened. The amount of opening the window and the determination conditions for the amount of opening the window in the ventilation operation are not limited to the above. Further, the user can set the amount of opening the window and the determination condition for the amount of opening the window in the ventilation operation, and performing the outside air intake or not, through the user terminal 3.

When the end condition for ventilation is satisfied, the control unit 111A controls each component so as to cause the vehicle 1 to stop the ventilation operation and return the vehicle 1 to the state before ventilation. More specifically, in the first embodiment, the control unit 111A instructs the power window ECU 12 to close the open window, and causes the air conditioning ECU 13 to stop blowing the air conditioner. When the air conditioner is in operation, the control unit 111A may switch from outside air intake to inside air circulation.

The end condition for ventilation is that a second action for instructing to end ventilation by the user is received, that a value detected by the sensor 15 satisfies the first condition indicating the end of ventilation, and that a predetermined time has elapsed since the start of ventilation. When any one of the above conditions is satisfied, it is determined that the end condition for ventilation is satisfied. The end condition for ventilation is an example of “a predetermined condition indicating the end of ventilation of the interior space in the vehicle cabin”.

The second action to indicate the end of ventilation is, for example, pressing the “end of ventilation” button or emitting a voice indicating the start of ventilation. The “end of ventilation” button may be provided separately from the “start of ventilation” button, or it may be the same button as the “start of ventilation” button, and may be switched on or off by pressing.

The first condition is, for example, that the difference between the temperature of the interior space in the vehicle cabin and the outside air temperature by the temperature sensor becomes equal to or less than a predetermined value, that the amount of change in the humidity of the interior space in the vehicle cabin by the humidity sensor becomes equal to or more than a predetermined value, and that the carbon dioxide concentration of the interior space in the vehicle cabin by the carbon dioxide concentration measuring device becomes equal to or less than a predetermined value. The first condition can be, for example, arbitrarily set by the user of the vehicle 1 through the user terminal 3, and one or more of the above conditions are set. When a plurality of first conditions are set, whether the plurality of conditions are OR conditions or AND conditions may be set by the user through the user terminal 3. The first condition is not limited to the above conditions, and may be set using any of the parameters indicating that the air in the interior space of the vehicle cabin has been replaced as one of the first conditions.

### <Processing Flow>

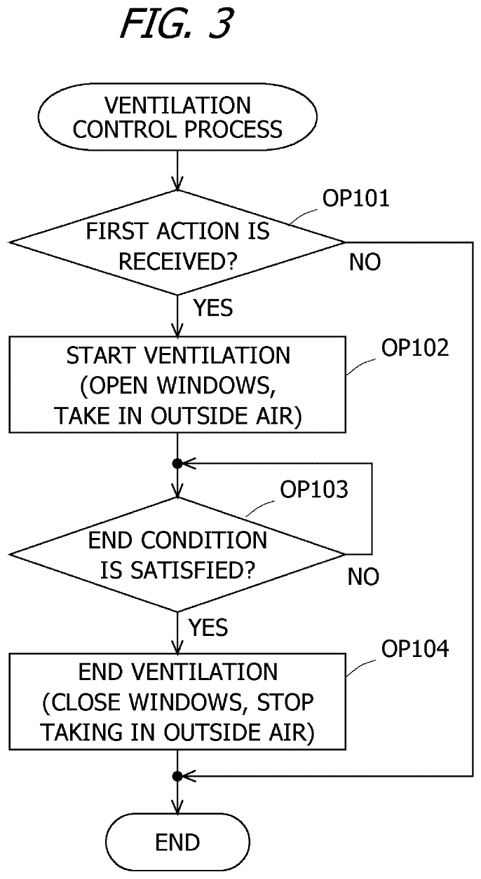

FIG. 3 is an example of a flowchart of a ventilation control process by the vehicle 1. The process illustrated in FIG. 3 is repeatedly executed while, for example, the vehicle 1 is in a state where the power window can be operated. The state in which the power window can be operated is, for example, the state in which the ignition switch is turned on. However, it is not limited to this, and the state in which the power window can operate depends on the type of vehicle. Although the execution entity of FIG. 3 is the CPU 111, in FIG. 3, the functional components will be described as execution entity for convenience.

In the OP 101, the control unit 111A determines whether or not the first action by the user has been received. When the first action is received (OP101: YES), the process proceeds to OP102. When the first action is not received (OP101: NO), the process illustrated in FIG. 3 ends.

In OP102, the control unit 111A instructs the power window ECU 12 to open the window a predetermined amount, and instructs the air conditioning ECU 13 to take in the outside air and to blow the outside air taken in at the maximum air flow amount, thereby starting the ventilation operation. In OP103, the control unit 111A determines whether or not the end condition for ventilation is satisfied. When the end condition for ventilation is satisfied (OP103: YES), the process proceeds to OP104. If the end condition for ventilation is not satisfied (OP103: NO), the processing in OP103 is repeated until the end condition for ventilation is satisfied.

In OP104, the control unit 111A instructs the power window ECU 12 to close the open window, and stops the air intake and air blowing of the air conditioner to the air conditioning ECU 13, thereby ending ventilation. Thereafter, the process illustrated in FIG. 3 ends. The process illustrated in FIG. 3 is an example, and the ventilation control process of the vehicle 1 is not limited to the process illustrated in FIG. 3.

### <Operations and Effects of the First Embodiment>

According to the first embodiment, the vehicle 1 performs an operation for ventilation, such as automatically opening windows a predetermined amount, when a first action instructing to start ventilation is performed by the user. As a result, the user can ventilate the interior space of the vehicle cabin simply by performing the first action, and the user's time and effort for ventilating the interior space of the vehicle cabin can be reduced. In addition, even when the driver tries to ventilate while driving, only the first action needs to be taken, so that safe driving can be maintained.

Also, in the first embodiment, when the end condition for ventilation is satisfied, the vehicle 1 closes the window that is open and returns it to the state before ventilation. As a result, it is possible to reduce the user's labor even at the end of ventilation.

### <Second Embodiment>

In the first embodiment, when the user is riding in the vehicle 1, the interior space of the vehicle cabin can be ventilated. In the second embodiment, a system is described in which a user remotely performs ventilation of an interior space in a vehicle cabin of the vehicle 1. In the second embodiment, the description overlapping with the first embodiment is omitted.

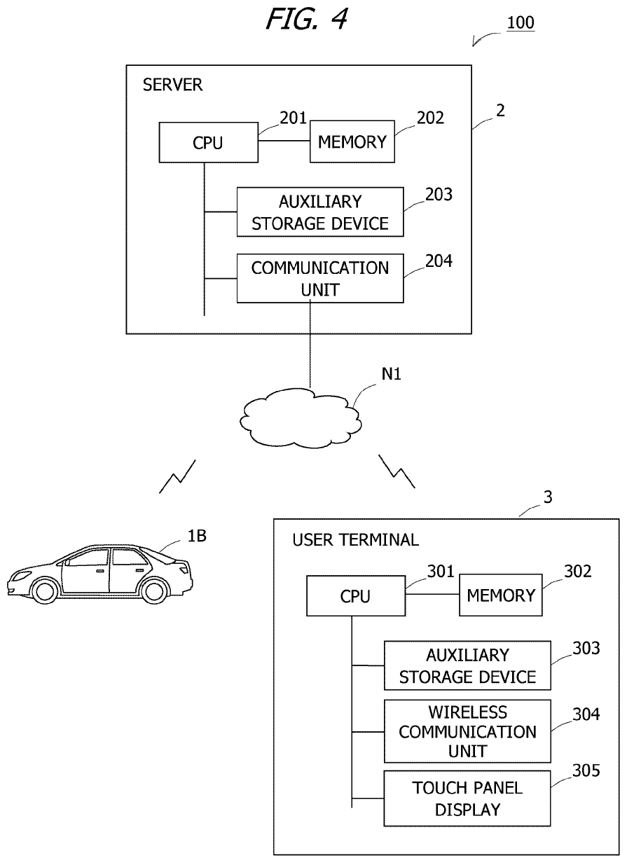

FIG. 4 is a diagram illustrating an example of a system configuration of the remote vehicle ventilation control system 100. The remote vehicle ventilation control system 100 is a system that performs ventilation of the interior space of the vehicle cabin of the vehicle 1B in accordance with an instruction to start ventilation from the user terminal 3 associated with the vehicle 1B. The remote vehicle ventilation control system 100 includes a server 2, a vehicle 1B, and a user terminal 3 associated with the vehicle 1B. The vehicle 1B, the server 2, and the user terminal 3 are connected to the network N1 and can communicate with each other through the network N1. The network N1 is, for example, a public network such as the Internet.

The user terminal 3 is, for example, a terminal used by a user who is an owner of the vehicle 1B. An application program for receiving the service of the remote vehicle ventilation control system 100 is installed in the user terminal 3. Further, through the application program, the user of the user terminal 3 registers itself as a user in association with the vehicle 1B in the remote vehicle ventilation control system 100. The user terminal 3 receives an operation of starting ventilation of the vehicle 1B from the user, and transmits a request for ventilation of the vehicle 1B to the server 2. The user terminal 3 is an example of a “terminal associated with a vehicle”.

The server 2 holds the association between the user of the user terminal 3 and the vehicle 1B by user registration by the user terminal 3. When the server 2 receives a request for ventilation of the vehicle 1B from the user terminal 3, the server 2 transmits a ventilation start instruction instructing the vehicle 1B to start ventilation.

When receiving the ventilation start instruction from the server 2, the vehicle 1B performs an operation for ventilation in the same manner as in the first embodiment. The control device 11 mounted on the vehicle 1B communicates with the server 2 through the communication unit 114. In the second embodiment, the first action to instruct to start ventilation by the user is to send a ventilation request. That is, in the second embodiment, for the control device 11, receiving the first action is receiving a ventilation start instruction. Further, in the second embodiment, the second action of instructing to end ventilation by the user is to send a request for the end of ventilation. That is, in the second embodiment, for the control device 11, receiving the second action is receiving a ventilation end instruction instructing to end ventilation.

In the second embodiment, the control device 11 instructs the power window ECU 12 to open a plurality of windows that can be opened and closed and that are provided in the vehicle 1B a predetermined amount in the ventilation operation of the vehicle 1B. The amount of opening the window is smaller compared to the amount of opening the window in the ventilation operation in the first embodiment, for example, about 10% of when the window is fully opened. In the second embodiment, since there is a case where no one is riding on the vehicle 1B, for example, in order to prevent a suspicious person from entering the vehicle 1B from the window, the window is not opened enough for a human arm to fit through. The present disclosure is not limited to this, and in the second embodiment, in the ventilation operation of the vehicle 1B, the control device 11 may further instruct the air conditioning ECU 13 to suck in the outside air, to blow the outside air taken in by maximizing the air blowing amount, or may instruct the air conditioning ECU 13 to suck in the outside air and to blow the air by maximizing the air blowing amount without opening the window. Other than these points, the control device 11 performs the similar processing (for example, FIG. 3) as in the first embodiment in the second embodiment.

Next, the hardware configuration of the server 2 and the user terminal 3 will be described. The server 2 includes a CPU 201, a memory 202, an auxiliary storage device 203, and a communication unit 204 as hardware configurations. The CPU 201, the memory 202, and the auxiliary storage device 203 are the similar as the CPU 111, the memory 112, and the auxiliary storage device 113, respectively.

The communication unit 204 is a module that connects, for example, a network cable such as a LAN (Local Area Network) card and an optical module, and includes a signal processing circuit. The communication unit 204 is not limited to a circuit that can be connected to a wired network, and may be a wireless signal processing circuit that can process wireless signals of a wireless communication network such as WiFi. Note that the hardware configuration of the server 2 is not limited to that illustrated in FIG. 4.

The user terminal 3 is, for example, a smartphone, a tablet terminal, a personal computer (PC), a wearable terminal, and the like. The user terminal 3 includes a CPU 301, a memory 302, an auxiliary storage device 303, a wireless communication unit 304, and a touch panel display 305 as hardware configurations. The CPU 301, the memory 302, the auxiliary storage device 303, and the wireless communication unit 304 are the similar as the CPU 111, the memory 112, the auxiliary storage device 113, and the communication unit 114, respectively. The touch panel display 305 receives an input of an operation of starting ventilation of the vehicle 1B from a user. In FIG. 4, the hardware configuration of the user terminal 3 is illustrated by extracting hardware components related to the use of the service of the remote vehicle ventilation control system 100, and the hardware configuration of the user terminal 3 is not limited to that illustrated in FIG. 4.

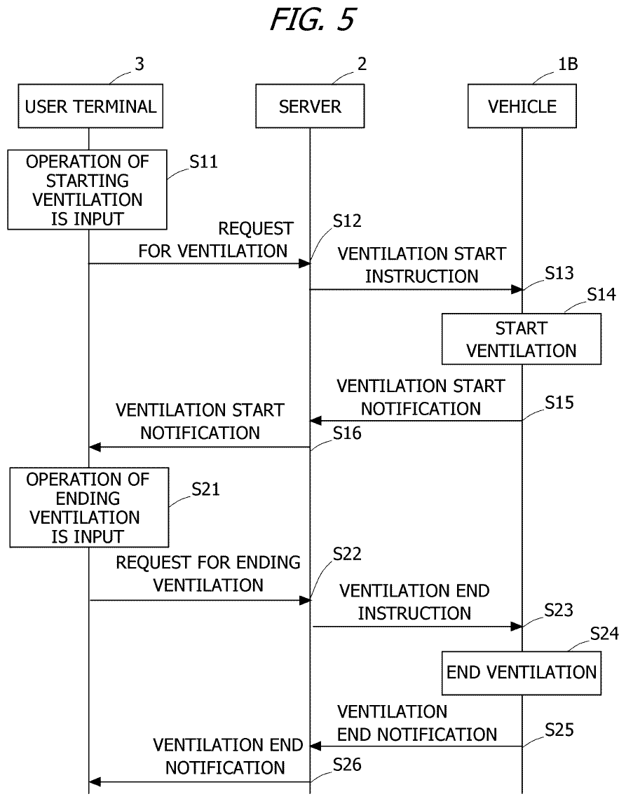

FIG. 5 is an example of a sequence of ventilation control of the vehicle 1B in the remote vehicle ventilation control system 100. The server 2 and the user terminal 3 execute the process illustrated in FIG. 5 by the CPU 201 and the CPU 301 executing a corresponding program, respectively.

In S11, the user inputs an operation of starting the ventilation of the vehicle 1B to the user terminal 3. In S12, the user terminal 3 receives an input of the operation of starting the ventilation of the vehicle 1B from the user, and transmits a request for the ventilation of the vehicle 1B to the server 2. In S13, the server 2 receives the request for ventilation of the vehicle 1B from the user terminal 3, confirms that the user of the user terminal 3 and the vehicle 1B are associated with each other, and transmits a ventilation start instruction to the vehicle 1B. The server 2 holds, for example, a database that holds information on the user, and holds, as the information on the user, information on the vehicle 1B associated with the user. Further, prior to S11, the server 2 performs user authentication through the user terminal 3, and has already identified the user of the user terminal 3.

In S14, the vehicle 1B receives the first action by receiving the ventilation start instruction from the server 2 (OP101 in FIG. 3), and starts the ventilation of the interior space in the vehicle 1B (OP102 in FIG. 3). As a result, a plurality of windows that can be opened and closed of the vehicle 1B are opened by a predetermined amount, and ventilation is started. In S15, the vehicle 1B (control device 11) transmits a ventilation start notification indicating that ventilation has been started to the server 2. In S16, the server 2 receives the ventilation start notification from the vehicle 1B and transmits the ventilation start notification to the user terminal 3 as a response to the request for ventilation.

In S21, the user inputs an operation of ending ventilation of the vehicle 1B to the user terminal 3. In S22, the user terminal 3 receives an input of an operation for ending ventilation of the vehicle 1B from the user, and transmits a request for ending ventilation of the vehicle 1B to the server 2. In S23, the server 2 receives the request for ending ventilation of the vehicle 1B from the user terminal 3, and transmits a ventilation end instruction instructing the vehicle 1B to end ventilation.

In S24, the vehicle 1B receives the second action by receiving the ventilation end instruction from the server 2, determines that the end condition for ventilation is satisfied (OP103 in FIG. 3), and ends the ventilation of the interior space in the vehicle 1B (OP104 in FIG. 3). As a result, the plurality of windows that had been opened by a predetermined amount can be closed. If the outside air intake and the air blowing are performed, the vehicle 1B (control device 11) stops them.

In S25, the vehicle 1B (control device 11) transmits a ventilation end notification indicating that the ventilation is ended to the server 2. In S26, the server 2 receives the ventilation end notification from the vehicle 1B and transmits the ventilation end notification to the user terminal 3 as a response to the request for ending ventilation.

In FIG. 5, an example in which the ventilation of the vehicle 1B is ended by the operation of the end of ventilation from the user has been described. However, as in the first embodiment, the ventilation of the vehicle 1B is ended even when other end conditions for ventilation are satisfied. For example, when the first condition in which the value detected by the sensor 15 indicates the end of ventilation is satisfied, the control device 11 detects that the first condition is satisfied and ends the ventilation of the interior space in the vehicle cabin of the vehicle 1B. Thereafter, as in the example illustrated in FIG. 5, the control device 11 transmits a ventilation end notification to the server 2, and the ventilation end notification is transmitted from the server 2 to the user terminal 3.

According to the second embodiment, the vehicle 1B can be automatically ventilated by operating the user terminal 3 from a place away from the vehicle 1B. When the user terminal 3 can be directly connected to the vehicle 1B via WiFi or the like, the user terminal 3 may instruct the control device 11 to start ventilation without going through the server 2. In this case, the control device 11 may start ventilation after performing authentication of the user terminal 3 in a predetermined manner.

### Other Embodiments

The embodiments described above are examples, and the present disclosure may be changed and carried out as appropriate without departing from the gist of the present disclosure.

In the first embodiment and the second embodiment, the detection of the approach of a suspicious person may be included in the end condition for ventilation of the vehicle 1 or the vehicle 1B. Windows are opened during ventilating, thereby it is likely to facilitate the entry of suspicious persons. By including the detection of the approach of a suspicious person in the end condition for ventilation, when someone approaches the vehicle 1 or the vehicle 1B, the open window can be automatically closed, and the security of the vehicle 1 or the vehicle 1B can be protected. The approach of the suspicious person is detected, for example, by a camera or a motion sensor installed toward the outside of the vehicle 1 or the vehicle 1B.

It is also possible to combine the first embodiment and the second embodiment. For example, when the received first action is to press the “ventilation start” button or to utter a voice indicating the start of ventilation, that is, when an instruction to start ventilation is received in the vehicle 1, the vehicle 1 may open a part or all of the plurality of windows that can be opened and closed a first amount. On the other hand, when the received first action is to receive a ventilation start instruction from an external device, that is, when the ventilation start instruction is received remotely, the vehicle 1 may open a part or all of the plurality of windows that can be opened and closed by a second amount smaller than the first amount. The content of the ventilation operation according to the content of the received first action (amount of opening the window, intake of outside air or not) may be set by the user through the user terminal 3.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a controller configured to:
receive a first action instructing to start ventilation of an interior space in a vehicle cabin by a user; and
cause the vehicle to perform a first operation including at least of opening a plurality of windows that can be opened and closed and that are provided in the vehicle when the first action is received.

2. The information processing apparatus according to claim 1, wherein, when a predetermined condition indicating an end of ventilation of the interior space in the vehicle cabin is satisfied, the controller is configured to cause the vehicle to end the first operation and cause the vehicle to return to a state before performing the first operation.

3. The information processing apparatus according to claim 1,
wherein the first action is to press a button instructing to start ventilation, to emit a voice instructing to start ventilation, or to transmit an instruction to start ventilation from a terminal associated with the vehicle, and
wherein the controller is configured to open the plurality of windows that are provided in the vehicle a first amount as the first operation when the button instructing to start ventilation is pressed or when a voice instructing to start ventilation is recognized, and open the plurality of windows that are provided in the vehicle a second amount as the first operation when an instruction to start ventilation is received from the terminal.

4. A vehicle comprising a controller configured to:
receive a first action instructing to start ventilation of an interior space in a vehicle cabin by a user; and
cause a vehicle to perform a first operation including at least opening a plurality of windows that can be opened and closed and that are provided in the vehicle when the first action is received.

5. A method executed by a computer comprising:
receiving a first action instructing to start ventilation of an interior space in a vehicle cabin by a user; and
causing a vehicle to perform a first operation including at least opening a plurality of windows that can be opened and closed and that are provided in the vehicle when the first action is received.
